(19) United States
(12) Patent Application Publication
(10) Pub. No.: US 2025/0232455 A1
(43) Pub. Date: Jul. 17, 2025

(54) ENCODING AND DECODING METHODS, ENCODER, DECODER, CODE STREAM, AND COMPUTER STORAGE MEDIUM

(71) Applicant: GUANGDONG OPPO MOBILE TELECOMMUNICATIONS CORP., LTD., Dongguan (CN)

(72) Inventors: Fuzheng YANG, Dongguan (CN); Ming LI, Dongguan (CN)

(21) Appl. No.: 19/171,513

(22) Filed: Apr. 7, 2025

Related U.S. Application Data
(63) Continuation of application No. PCT/CN2022/125932, filed on Oct. 18, 2022.

(51) Int. Cl. G06T 7/246; G06T 17/00; H04N 19/96

(52) U.S. Cl. CPC G06T 7/246; G06T 17/005; H04N 19/96; G06T 2207/10028

(57) ABSTRACT

Encoding and decoding methods, an encoder, a decoder, and a computer storage medium are provided. At an encoding end and a decoding end, for whether location information of a current node satisfies a first condition and a second condition, respectively, an identifier of the current node is valued. In addition, at the decoding end, the value of the identifier of the current node can be decoded from the code stream, to obtain whether a planar mode is allowed to be used to decode the current node.

### CROSS-REFERENCE TO RELATED APPLICATION

This is a continuation application of International Patent Application No. PCT/CN2022/125932, filed on Oct. 18, 2022, the content of which is hereby incorporated by reference in its entirety.

### BACKGROUND

In a Geometry-based Point Cloud Compression (G-PCC) encoding and decoding framework, geometric information and corresponding attribute information of a point cloud are encoded separately. For the encoding of the geometric information, there are two frameworks of octree-based or Triangle soup (Trisoup)-based.

In an octree-based geometric information encoding framework, whether a planar mode is allowed to be used for nodes of the octree in a constructing of a context model introduces significant computational complexity in related art, resulting in an inability to better utilize encoding and decoding gains offered by the planar mode.

### SUMMARY

Embodiments of the present disclosure relate to planar mode technologies in point cloud encoding and decoding, and in particular to encoding and decoding methods, an encoder, a decoder, a bitstream, and a computer storage medium.

The technical solutions of the embodiments of the present disclosure may be implemented as follows.

According to a first aspect, an embodiment of the present disclosure provides a point cloud decoding method, the method is applied to a decoder, and the method includes the following operations.

A point cloud bitstream is decoded, and location information of a current node is determined.

It is determined that an identifier of the current node has a first identifier value when the location information of the current node satisfies a first condition.

It is determined that the identifier of the current node has a second identifier value when the location information of the current node satisfies a second condition.

The identifier indicates whether a planar mode is allowed to be used to decode the current node; the first identifier value indicates that the planar mode is allowed to be used to decode the current node; and the second identifier value indicates that the planar mode is not allowed to be used to decode the current node.

According to a second aspect, an embodiment of the present disclosure provides a point cloud decoding method, the method is applied to a decoder, and the method includes the following operations.

A point cloud bitstream is decoded, and an identifier of a current node is determined.

The identifier of the current node indicates whether a planar mode is allowed to be used to decode the current node.

According to a third aspect, an embodiment of the present disclosure provides a point cloud encoding method, the method is applied to an encoder, and the method includes the following operations.

Location information of a current node is determined.

It is determined that an identifier of the current node has a first identifier value when the location information of the current node satisfies a first condition.

It is determined that the identifier of the current node has a second identifier value when the location information of the current node satisfies a second condition.

The identifier indicates whether a planar mode is allowed to be used to encode the current node; the first identifier value indicates that the planar mode is allowed to be used to encode the current node; and the second identifier value indicates that the planar mode is not allowed to be used to encode the current node.

### BRIEF DESCRIPTION OF THE DRAWINGS

FIG. 1 is a schematic diagram of a network architecture for point cloud encoding and decoding according to an embodiment of the present disclosure.

FIG. 2 is a schematic diagram of the composition framework of a G-PCC encoder.

FIG. 3 is a schematic diagram of the composition framework of a G-PCC decoder.

FIG. 4 is a schematic flowchart of an optional point cloud decoding method according to an embodiment of the present disclosure.

FIG. 5 is a schematic flowchart of another optional point cloud decoding method according to an embodiment of the present disclosure.

FIG. 6 is a schematic flowchart of an optional point cloud encoding method according to an embodiment of the present disclosure.

FIG. 7 is a first schematic diagram of an optional structure of a decoder according to an embodiment of the present disclosure.

FIG. 8 is a second schematic diagram of an optional structure of a decoder according to an embodiment of the present disclosure.

FIG. 9 is a first schematic diagram of an optional structure of an encoder according to an embodiment of the present disclosure.

FIG. 10 is a third schematic diagram of an optional structure of a decoder according to an embodiment of the present disclosure.

FIG. 11 is a second schematic diagram of an optional structure of an encoder according to an embodiment of the present disclosure.

### DETAILED DESCRIPTION

In order to understand features and technical contents of the embodiments of the present disclosure in more detail, the implementations of the embodiments of the present disclosure will be described in detail below in combination with the accompanying drawings, the accompanying drawings are for reference only but are not intended to limit the embodiments of the present disclosure.

Unless otherwise defined, all technical and scientific terms used herein have the same meanings as commonly understood by those skilled in the technical field of the present disclosure. The terms used herein is for the purpose of describing the embodiments of the present disclosure and is not intended to limit the scope of the present disclosure.

In the following description, reference is made to “some embodiments” that describe a subset of all possible embodiments, but it should be understood that “some embodiments” may be the same subset or different subsets of all possible embodiments and may be combined with each other without conflict. It is also to be pointed out that the term “first/second/third” in embodiments of the present disclosure is only used to distinguish similar objects, and does not represent a specific order of objects. It should be understood that “first/second/third” may be interchanged in a specific order or priority order where permitted, so that the embodiments of the present disclosure described herein may be implemented in an order other than that illustrated or described herein.

Prior to further detailed description of the embodiments of the present disclosure, terms and terminology referred to in the embodiments of the present disclosure will be explained, and the terms and terminology are applicable to the following interpretation.
Point Cloud Compression (PCC);
Geometry-based Point Cloud Compression (G-PCC or GPCC);
Video-based Point Cloud Compression (V-PCC or VPCC);
Octree;
Triangle soup (Trisoup);
Intra Prediction;
Look Up Table (LUT);
Red-Green-Blue (RGB);
Luminance-Chrominance (YUV);
Level of Detail (LOD);
Predicting Transform;
Lifting Transform;
Region Adaptive Hierarchal Transform (RAHT);
Context-based Adaptive Binary Arithmetic Coding (CABAC).

A point cloud is a three-dimensional representation of a surface of an object. The point cloud (i.e., data) of the surface of the object may be collected through collecting devices such as photoelectric radar, laser radar, a laser scanner, and a multi-view camera.

The point cloud refers to a collection of a massive number of three-dimensional points, where points in the point cloud may include location information of points and attribute information of the points. For example, the location information of a point may be three-dimensional coordinate information of the point. The location information of the point may also be referred to as geometric information of the point. For example, the attribute information of the point may include colour information and/or reflectance, and the like. For example, colour information may be information in any colour space, such as RGB information, where R represents Red, G represents Green, and B represents Blue. For another example, colour information may be Luminance-Chrominance (i.e., YCbCr (YUV)) information, where Y represents luminance, Cb (U) represents blue chrominance, and Cr (V) represents red chrominance.

Points in a point cloud obtained based on laser measurement principles may include three-dimensional coordinate information of the points and a laser reflectance of the points. For another example, points in a point cloud obtained based on photogrammetric principles may include three-dimensional coordinate information of the points and colour information of the points. For another example, points in a point cloud obtained by combining laser measurement principles and photogrammetric principles may include three-dimensional coordinate information of the points, laser reflectance of the points, and colour information of the points.

Point clouds may be classified into the following types based on their acquisition manners:
A first type is static point clouds, in which an object is stationary, and a device for acquiring the point clouds is also stationary.
A second type is dynamic point clouds, in which the object is moving, but the device for acquiring the point clouds is stationary.
A third type is dynamically acquiring point clouds, in which the device for acquiring the point clouds is moving.
For example, point clouds may be classified into two major categories according to their applications:
Category 1: Machine perception point clouds, applied in scenarios such as autonomous navigation systems, real-time inspection systems, geographic information systems, visual sorting robots, and disaster relief robots.
Category 2: Human visual perception point clouds, applied in point cloud application scenarios such as digital cultural heritage, free-viewpoint broadcasting, three-dimensional immersive communication, and three-dimensional immersive interaction.

Since a point cloud is a collection of massive points, storing the point cloud not only consumes significant memory, but also is not conducive to transmission, and there is no such a large bandwidth to support the direct transmission of the point cloud at a network layer without compression. Therefore, it is necessary to compress the point cloud.

Up to now, point cloud compression frameworks for point cloud compression may be a G-PCC encoding and decoding framework or a V-PCC framework encoding and decoding framework provided by a Moving Picture Experts Group (MPEG), and may also be an Audio Video Standard (AVS)-PCC framework provided by the AVS. The G-PCC encoding and decoding framework may be used for compressing static point clouds of the first type and dynamically acquiring point clouds of the third type, while the V-PCC encoding and decoding framework may be used for compressing dynamic point clouds of the second type. In the embodiments of present disclosure, the description primarily focuses on the G-PCC encoding and decoding framework.

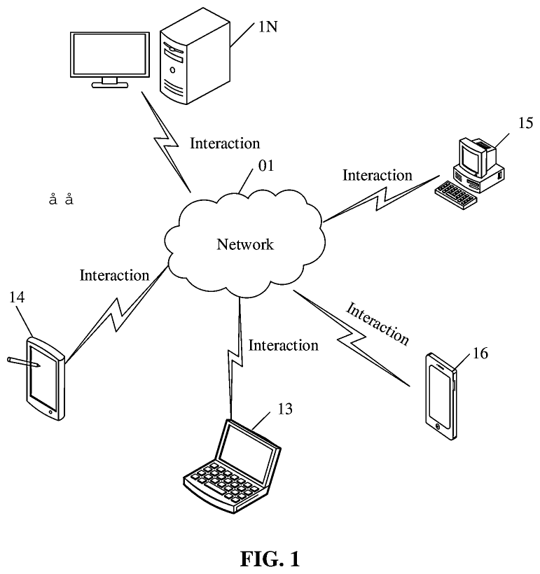

The embodiments of the present disclosure provide a network architecture of a point cloud encoding and decoding system that includes both decoding and encoding methods. FIG. 1 a schematic diagram of a network architecture for point cloud encoding and decoding according to an embodiment of the present disclosure. As illustrated in FIG. 1, the network architecture includes one or more electronic devices 13 to IN and a communication network 01, where the electronic devices 13 to IN may perform video interaction through the communication network 01. The electronic devices, during implementation, may be various types of devices with point cloud encoding and decoding function, such as mobile phones, tablets, personal computers, personal digital assistants, navigation devices, digital phones, video phones, televisions, sensors, servers, etc., which is not limited by embodiments of the present disclosure. The decoder or encoder in the embodiments of the present disclosure may be the above electronic devices.

These electronic devices in the embodiments of the present disclosure have a point cloud encoding and decoding function and generally include a point cloud encoder (i.e., encoder) and a point cloud decoder (i.e., decoder).

The following takes the G-PCC encoding and decoding framework as an example to explain the related art.

It is to be understood that in the point cloud G-PCC encoding and decoding framework, a point cloud of input three-dimensional image model is partitioned into slices, and each slice may be encoded independently.

FIG. 2 is a schematic diagram of the composition framework of a G-PCC encoder. As illustrated as FIG. 2, the G-PCC encoder is applied to a point cloud encoder. In the G-PCC encoding framework, after an input point cloud is partitioned into slices, each slice is encoded independently. Geometric information of the point cloud and attribute information corresponding to points of the point cloud are encoded separately in a slice. The G-PCC encoder first encodes the geometric information. The encoder performs coordinate transform on the geometric information to enable the point cloud is entirely contained within a bounding box. Then the G-PCC encoder performs quantization which mainly serves the purpose of scaling. Due to the rounding in quantization, some points have the same geometric information. Whether to remove repeat points is determined according to parameters. The process of the quantization and the removal for repeat points is also called a voxelization process. Next, the bounding box is partitioned based on the octree. There are two frameworks of octree-based or Trisoup-based for encoding geometric information according to different of octree partitioning depth.

In the octree-based geometric information encoding framework, the bounding box is equally partitioned into eight sub-cubes, and the occupancy bits of these sub-cubes are recorded (where 1 indicates non-empty and 0 indicates empty). Non-empty sub-cubes are further partitioned into eight equal parts, and this process continues until the leaf nodes obtained through partitioning are unit cubes of 1×1×1 in size. During the process, intra prediction for occupancy bits is performed by using a spatial correlation between a node and neighbouring nodes. Finally, CABAC encoding based on a context model is performed to generate a binary geometry bitstream, which is also referred to as a geometry bitstream.

In the Trisoup-based geometric information encoding framework, octree partitioning is also performed initially, however, it differs from the octree-based geometric information encoding method in that: the point cloud is not required to be partitioned into unit cubes of 1×1×1 in size. Instead, partitioning stops when blocks reach a side length of W. Based on a surface formed by a distribution of the point cloud within each block, up to twelve vertices are obtained where the surface intersects with twelve edges of the block. Finally, vertex coordinates of each block are encoded sequentially to generate a binary geometry bitstream, which is also referred to as a geometry bitstream.

After completing geometric information encoding, the G-PCC encoder reconstructs the geometric information and uses reconstructed geometric information to encode attribute information of the point cloud. Currently, the encoding for attribute of the point cloud primarily focuses on encoding colour information of the points in the point cloud. The encoder first may perform colour space conversion on the colour information of the points. For example, when colour information of points in an input point cloud is represented by using a RGB colour space, the encoder may convert the colour information from the RGB colour space to a YUV colour space. Then, reconstructed geometric information is used to re-colour the point cloud, ensuring that un-encoded attribute information corresponds to the reconstructed geometric information. Two main transform methods are used for encoding colour information. One method is distance-based lifting transform depending on Level of Detail (LOD) partitioning. Another method is to directly perform Region Adaptive Hierarchical Transform (RAHT). Both methods transform colour information from a spatial domain to a frequency domain, obtaining high-frequency and low-frequency coefficients, which are then quantized and encoded to generate a binary attribute bitstream, i.e., an attribute bitstream.

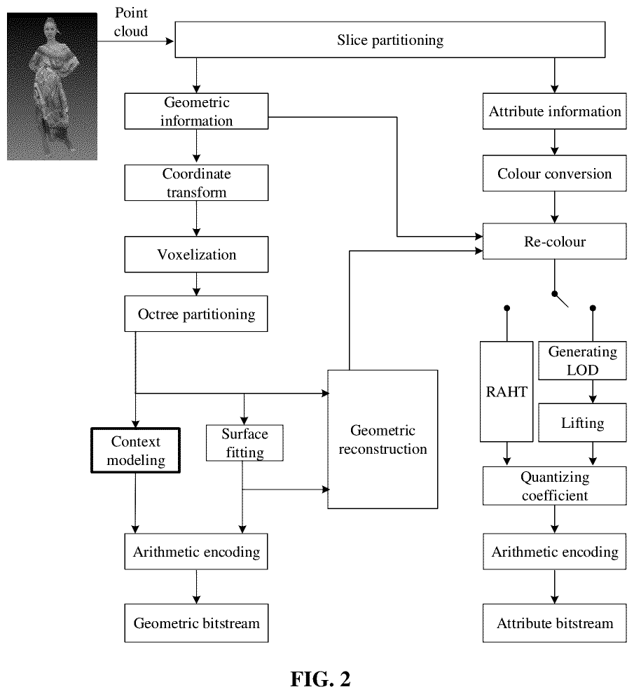

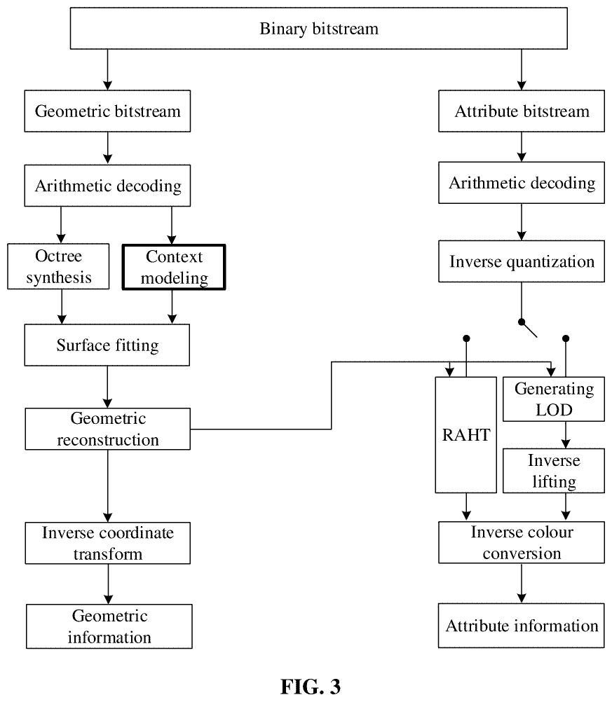

FIG. 3 is a schematic diagram of the composition framework of a G-PCC decoder. As illustrated in FIG. 3, the G-PCC decoder is applied to a point cloud decoder. In the G-PCC decoding framework, after obtaining a binary bitstream, a geometric bitstream and an attribute bitstream of the binary bitstream are decoded independently. When decoding the geometric bitstream, arithmetic decoding, octree synthesis, surface fitting, geometric reconstruction, and inverse coordinate transform are performed to obtain geometric information of the point cloud. When decoding the attribute bitstream, arithmetic decoding, inverse quantization, inverse lifting based on LOD or inverse transform based on RAHT, and inverse colour conversion are performed to obtain attribute information of the point cloud. The slice to-be-encoded may be recovered based on the geometric information and attribute information. After merging the slices, a three-dimensional image model of the input point cloud is restored.

In related art, as illustrated in FIG. 2 or FIG. 3, during context modeling, it is necessary to determine whether the current node is eligible to use the planar mode. Nodes that are not eligible use an occupancy bit pattern, while nodes that are eligible will continue to determine whether to use the planar mode based on a distribution of sub-nodes.

Two eligibility conditions for determining whether the current node is eligible to use the planar mode are following:
1. A local occupancy density of the node is greater than a preset threshold.
2. A proportion of nodes that have already used a planar encoding mode in a certain direction (x, y, or z) is greater than a corresponding preset threshold (there are a total of three thresholds corresponding to the x, y, and z directions).

It can be seen that the eligibility for using the planar mode is mainly determined based on a relationship between the local occupancy density of nodes and the preset threshold, as well as the proportion of nodes that have already used the planar mode in a certain direction (such as x, y, or z) is greater than the corresponding preset threshold (there are a total of three thresholds corresponding to the x, y, and z directions). However, the method involves real-time updates of two variables: the local occupancy density of nodes and the proportion of nodes that have already used the planar mode, which brings significant computational complexity. Additionally, the setting of four thresholds increases a difficulty of optimization of the method, resulting in an inability to better utilize more encoding gain offered by the planar encoding mode.

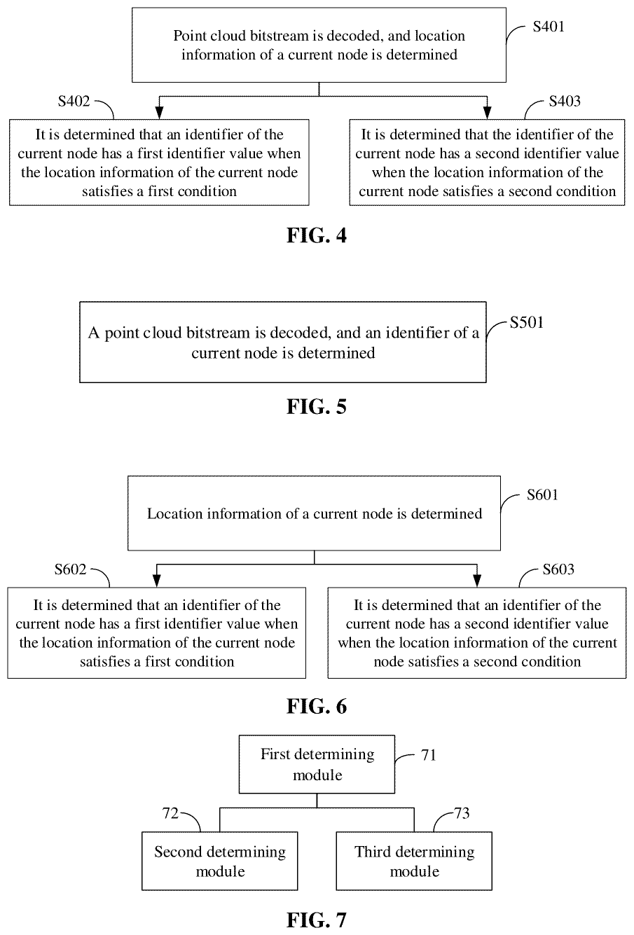

Based on this, an embodiment of the present disclosure provides a point cloud decoding method, and the method is applied to a decoder. FIG. 4 is a schematic flowchart of an optional point cloud decoding method according to the embodiment of the present disclosure. Referring to FIG. 4, the method may include the following operations.

At S401, a point cloud bitstream is decoded, and location information of a current node is determined.

For the decoding end, when decoding the point cloud bitstream, the location information of the current node is determined, where the current node is one of nodes obtained through an octree partitioning. In S401, after obtaining an octree, the nodes of the octree are traversed from a root node of the octree, the location information of the current node may include: a number of a level where the current node is located, and neighbouring nodes of the current node. For example, when the current node is the root node, the number of the level where the current node is located is 1, a number of a level where sub-nodes of the root node are located is 2, a number of a level where sub-nodes of the sub-nodes of the root node are located is 3, and so forth. Neighbouring nodes of the current node may be nodes corresponding to a sub-cube located above, below, in front of, behind, to the left of, and to the right of a sub-cube corresponding to the current node. That is, the neighbouring nodes of the current node may include six neighbouring nodes.

At S402, it is determined that an identifier of the current node has a first identifier value when the location information of the current node satisfies a first condition.

At S403, it is determined that the identifier of the current node has a second identifier value when the location information of the current node satisfies a second condition.

After determining the location information of the current node through S401, it is determined whether the location information of the current node satisfies the first condition or the second condition. The value of the identifier of the current node is set to a first identifier value when the location information of the current node satisfies the first condition. The value of the identifier of the current node is set to a second identifier value when the location information of the current node satisfies the second condition. The identifier indicates whether a planar mode is allowed to be used to decode the current node. The first identifier value indicates that the planar mode is allowed to be used to decode the current node; and the second identifier value indicates that the planar mode is not allowed to be used to decode the current node. In this way, the value of the identifier of the current node is determined based on the condition satisfied by the location information of the current node, which simplifies the computational complexity while improving the encoding and decoding gains of the planar mode compared to a manner used in related art for determining whether the planar mode is allowed to be used for decoding or encoding the current node.

For the above first condition, in an optional embodiment, the first condition includes that:

the location information of the current node indicates that the number of nodes in a N-th layer in which the current node is located is less than a product of the number of nodes in a (N−1)-th layer and a first preset value; or the location information of the current node indicates that an occupancy pattern of neighbouring nodes of the current node is equal to a second preset value.

It is to be understood that the number (i.e., the N-th layer) of the layer in which the current node is located may be obtained from the location information of the current node, and thus the number of nodes in the N-th layer may be obtained. The product of the number of nodes in the (N−1)-th layer and a first preset value is calculated, and then it is determined whether the number of nodes in the N-th layer is less than the product. Additionally, the occupancy pattern of neighbouring nodes of the current node may be obtained from the location information of the current node, where the occupancy pattern of neighbouring nodes is an integer formed by occupancy bits of the neighbouring nodes. It is determined whether the occupancy pattern of neighbouring nodes of the current node is equal to a second preset value.

Based on the above determination, when the number of nodes in the N-th layer in which the current node is located is less than the above product, and the occupancy pattern of neighbouring nodes of the current node is equal to the second preset value, it is determined that the location information of the current node satisfies the first condition, and the value of the identifier of the current node is set to the first identifier value.

For the above second condition, in an optional embodiment, the second condition includes that:

the location information of the current node indicates that the number of nodes of a N-th layer in which the current node is located is greater than a product of the number of nodes of a (N−1)-th layer and a first preset value, and the location information of the current node indicates that an occupancy pattern of neighbouring nodes of the current node is not equal to a second preset value.

It is to be understood that the number (i.e., the N-th layer) of the layer in which the current node is located may be obtained from the location information of the current node, and thus the number of nodes in the N-th layer may be obtained. The product of the number of nodes in the (N−1)-th layer and a first preset value is calculated, and then it is determined whether the number of nodes in the N-th layer is greater than the product. Additionally, the occupancy pattern of neighbouring nodes of the current node may be obtained from the location information of the current node, where the occupancy pattern of neighbouring nodes is an integer formed by occupancy bits of the neighbouring nodes. It is determined whether the occupancy pattern of neighbouring nodes of the current node is equal to a second preset value.

Based on the above determination, when the number of nodes in the N-th layer in which the current node is located is greater than the above product, and the occupancy pattern of neighbouring nodes of the current node is not equal to the second preset value, it is determined that the location information of the current node satisfies the second condition, and the value of the identifier of the current node is set to the second identifier value.

For the root node of the octree, in an optional embodiment, when the number of nodes of the N-th layer is 1, the number of nodes of the (N−1)-th layer is 0.

It is to be noted that when the current node is the root node of the octree, i.e., when the number of nodes in the N-th layer is 1, the current node is the root node. Since the root node does not have a node in a previous layer, the number of nodes in the (N−1)-th layer is set to 0 herein.

Further, in order to improve the encoding and decoding gain, the first preset value is usually 2.

For the second preset value, in an optional embodiment, the second preset value is any one integer greater than or equal to 0 and less than or equal to 63.

It is to be understood that since the current node has 6 neighbouring nodes, it can be inferred that the occupancy pattern formed by the occupancy bits of these 6 neighbouring nodes may be an integer greater than or equal to 0 and less than or equal to 63. Therefore, the second preset value may be chosen as any one integer greater than or equal to 0 and less than or equal to 63.

For the identifier of the current node, in an optional embodiment, the first identifier value is 1, and the second identifier value is 0.

In practical applications, the first identifier value is usually set to 1, and the second identifier value is usually set to 0. That is, when the value of the identifier of the current node is 1, the planar mode is allowed to be used to decode the current node, and when the value of the identifier of the current node is 0, the planar mode is not allowed to be used to decode the current node.

It is to be noted that a situation where the number of nodes in the N-th layer in which the current node is located is equal to the product of the number of nodes in the (N−1)-th layer and the first preset value may belong to either the first condition or the second condition. In other words, it may be a case where the identifier of the current node is set to the first identifier value when the number of nodes in the N-th layer in which the current node is located is less than or equal to the aforementioned product or when the occupancy pattern of neighbouring nodes of the current node is equal to the second preset value. Optionally, it may also be a case where the identifier of the current node is set to the second identifier value when the number of nodes in the N-th layer in which the current node is located is greater than or equal to the aforementioned product, and the occupancy pattern of neighbouring nodes of the current node is not equal to the second preset value, which is not limited in the embodiments of the present disclosure.

In addition, an embodiment of the present disclosure also provides a point cloud decoding method, and the method is applied to a decoder. FIG. 5 is a schematic flowchart of another optional point cloud decoding method according to the embodiment of the present disclosure. Referring to FIG. 5, the method may include the following operations.

At S501, a point cloud bitstream is decoded, and an identifier of a current node is determined.

The identifier of the current node indicates whether a planar mode is allowed to be used to decode the current node.

It is to be noted that when the encoding end assigns a value to the identifier of the current node by adopting the manner of satisfying the first condition or the second condition as described above, encodes the value of the identifier of the current node and signals the encoded bits into a bitstream, the decoding end may decode the bitstream directly to obtain the value of the identifier of the current node.

When the identifier of the current node obtained through decoding is the first identifier value, the planar mode is allowed to be used to decode the current node. When the identifier of the current node obtained through decoding is the second identifier value, the planar mode is not allowed to be used to decode the current node.

For the encoding end, consistent with the manner in which the decoding end assigns a value to the identifier of the current node, an embodiment of the present disclosure further provides a point cloud encoding method, and the method is applied to an encoder. FIG. 6 is a schematic flowchart of an optional point cloud encoding method according to the embodiment of the present disclosure. Referring to FIG. 6, the method may include the following operations.

At S601, location information of a current node is determined.

At S602, it is determined that an identifier of the current node has a first identifier value when the location information of the current node satisfies a first condition.

At S603, it is determined that an identifier of the current node has a second identifier value when the location information of the current node satisfies a second condition.

The identifier indicates whether a planar mode is allowed to be used to encode the current node; the first identifier value indicates that the planar mode is allowed to be used to encode the current node; and the second identifier value indicates that the planar mode is not allowed to be used to encode the current node.

In an optional embodiment, the first condition includes that:

the location information of the current node indicates that the number of nodes in a N-th layer in which the current node is located is less than a product of the number of nodes in a (N−1)-th layer and a first preset value; or the location information of the current node indicates that an occupancy pattern of neighbouring nodes of the current node is equal to a second preset value.

In an optional embodiment, the second condition includes that:
the location information of the current node indicates that the number of nodes of a N-th layer in which the current node is located is greater than a product of the number of nodes of a (N−1)-th layer and a first preset value, and the location information of the current node indicates that an occupancy pattern of neighbouring nodes of the current node is not equal to a second preset value.

In an optional embodiment, when the number of nodes of the N-th layer is 1, the number of nodes of the (N−1)-th layer is 0.

In an optional embodiment, the first preset value is 2.

In an optional embodiment, the second preset value is any one integer greater than or equal to 0 and less than or equal to 63.

In an optional embodiment, the first identifier value is 1, and the second identifier value is 0.

The embodiments of the present disclosure provides encoding and decoding methods. At an encoding end, the location information of the current node is determined. At the decoding end, the point cloud bitstream is decoded, and the location information of the current node is determined; when the location information of the current node satisfies a first condition, it is determined that an identifier of the current node has a first identifier value; when the location information of the current node satisfies a second condition, it is determined that the identifier of the current node has a second identifier value; the identifier indicates whether a planar mode is allowed to be used to decode the current node; the first identifier value indicates that the planar mode is allowed to be used to decode the current node; and the second identifier value indicates that the planar mode is not allowed to be used to decode the current node. In this way, at the encoding and decoding ends, a value of the identifier of the current node is assigned accordingly based on whether the location information of the current node satisfies the first condition or the second condition, so that whether the planar mode is allowed to be used for decoding or encoding the current node can be determined with reduces computational effort. Moreover, at the decoding end, the value of the identifier of the current node can be decoded from the bitstream, thereby determining whether the planar mode is allowed to be used for decoding the current node, which simplifies the computational complexity while improving the encoding and decoding gains of the planar mode compared to a manner used in related art for determining whether the planar mode is allowed to be used for decoding or encoding the current node.

The following is an example to illustrate the point cloud encoding and decoding methods described in one or more of the above embodiments.

In the example, a new planar mode determination method based on the number of nodes in an octree level of point cloud and the occupancy pattern of the neighbouring nodes of the current node is proposed, and a unified eligibility value (equivalent to the above identifier) for the planar mode is set for all directions of nodes in a certain layer under the octree frame. Taking the encoding end as an example, the specific implementations at the encoding end is described as follows.

The eligibility value for the planar mode of the current node is determined based on the number OccNodeCnt[Dpth] of nodes at a Dpth level of the octree, the number OccNodeCnt[Dpth−1] of nodes at a Dpth−1 level, and an occupancy pattern of neighbouring nodes of the current node as follows:

PlanarEligibleByRate[k]=OccNodcCnt[Dpth]<(OccNodeCnt[Dpth−1]*2)∥OccNeighPat

Herein, k represents the current node, PlanarEligibleByRate[k] represents the value of the identifier of the current node, OccNodeCnt[Dpth] represents the number of nodes at the Dpth level, OccNodeCnt[Dpth−1] represents the number of nodes at the Dpth−1 level, and OccNeighPat represents a value within a value range of occupancy pattern, i.e., the above second preset value.

That is, taking the first preset value of 2 and the second preset value of 0 as an example, if OccNodeCnt[Dpth] is less than twice OccNodeCnt[Dpth−1], or if the occupancy pattern of neighbouring nodes of the current node is 0, PlanarEligibleByRate[k] is set to 1; otherwise, it is set to 0.

It is to be noted that the specific implementation description at the decoding end is identical to that at the encoding end.

Additionally, an optional method for determining the identifier of the current node is that the above second preset value may be 2 or any other value; in the condition of !OccNeighPat, OccNeighPat may be any one integer within the range [0, 63].

In the example, the eligibility value for the planar mode is determined by using the number of nodes at different octree levels in the point cloud and the occupancy pattern of neighbouring nodes of the current node. This approach eliminates a process of determining an eligibility value for each node individually and updating probability, and reduces computational complexity compared to the related art. Meanwhile, the eligibility of all nodes at a certain level for the planar mode is determined more accurately by adopting the actual density, resulting in performance gains, as illustrated in Table 1 and Table 2.

TABLE 1

Geometry BD-TotalRate (%)

| Test sequence | D1 | D2 |
|---|---|---|
| Cat1-A average | 0.0% | 0.0% |
| Cat2-B average | −0.2% | −0.2% |
| Cat3-fused average | −0.4% | −0.4% |
| Cat3-frame average | 0.0% | 0.0% |
| Overall average | −0.1% | −0.1% |

| | |
|---|---|
| Avg. Enc Time[%] | 97% |
| Avg. Dec Time[%] | 98% |

TABLE 2

| | Geometry bpip ratio (%) |
|---|---|
| Test sequence | D1 |
| Cat1-A average | 99.5% |
| Cat2-B average | 99.9% |
| Cat3-fused average | 99.8% |
| Cat3-frame average | 100.0% |
| Overall average | 99.8% |
| Avg. Enc Time[%] | 95% |
| Avg. Dec Time[%] | 94% |

As can be seen from Table 1 and Table 2 above, under a condition of lossy compression of geometric information, BD-Rate represents a percentage by which an encoding bitrate of the method in the example is saved (when BD-Rate is negative) or increased (when BD-Rate is positive) compared to the related art, when achieving the same encoding quality; under a condition of lossless compression of geometric information, Bpip Ratio represents a percentage of the encoding bitrate of the method in the example relative to that of related art, with no loss in point cloud quality, and the lower the value, the greater the bitrate savings achieved by the method in the example.

Based on the same inventive concept as the above embodiments, an embodiment of the present disclosure provides a decoder. FIG. 7 is a first schematic diagram of an optional structure of a decoder according to the embodiment of the present disclosure. The decoder 700 may include a first determining module 71, a second determining module 72 and a third determining module 73.

The first determining module 71 is configured to decode a point cloud bitstream and determine location information of a current node.

The second determining module 72 is configured to determine that an identifier of the current node has a first identifier value when the location information of the current node satisfies a first condition.

The third determining module 73 is configured to determine that the identifier of the current node has a second identifier value when the location information of the current node satisfies a second condition.

The identifier indicates whether a planar mode is allowed to be used to decode the current node; the first identifier value indicates that the planar mode is allowed to be used to decode the current node; and the second identifier value indicates that the planar mode is not allowed to be used to decode the current node.

In an optional embodiment, the first condition includes that:
the location information of the current node indicates that the number of nodes in a N-th layer in which the current node is located is less than a product of the number of nodes in a (N−1)-th layer and a first preset value; or the location information of the current node indicates that an occupancy pattern of neighbouring nodes of the current node is equal to a second preset value.

In an optional embodiment, the second condition includes that:
the location information of the current node indicates that the number of nodes of a N-th layer in which the current node is located is greater than a product of the number of nodes of a (N−1)-th layer and a first preset value, and the location information of the current node indicates that an occupancy pattern of neighbouring nodes of the current node is not equal to a second preset value.

In an optional embodiment, when the number of nodes of the N-th layer is 1, the number of nodes of the (N−1)-th layer is 0.

In an optional embodiment, the first preset value is 2.

In an optional embodiment, the second preset value is any one integer greater than or equal to 0 and less than or equal to 63.

In an optional embodiment, the first identifier value is 1, and the second identifier value is 0.

In practical applications, the first determining module 71, the second determining module 72, and the third determining module 74 may be implemented by processor(s) located on the decoder, specifically by devices such as a Central Processing Unit (CPU), a Microprocessor Unit (MPU), a Digital Signal Processor (DSP), or a Field Programmable Gate Array (FPGA).

An embodiment of the present disclosure provides a decoder. FIG. 8 is second schematic diagram of an optional structure of a decoder according to an embodiment of the present disclosure. The decoder 800 includes a fourth determining module 81.

The fourth determining module 81 is configured to decode a point cloud bitstream and determine an identifier of the current node. The identifier of the current node indicates whether a planar mode is allowed to be used to decode the current node.

In practical applications, the fourth determining module 81 may be implemented by a processor located on the decoder, specifically by devices such as the CPU, the MPU, the DSP, or the FPGA.

An embodiment of the present disclosure provides an encoder. FIG. 9 is first schematic diagram of an optional structure of an encoder according to the embodiment of the present disclosure. The encoder 900 may include a fifth determining module 91, a sixth determining module 92 and a seventh determining module 93.

The fifth determining module 91 is configured to determine location information of a current node.

The sixth determining module 92 is configured to determine that an identifier of the current node has a first identifier value when the location information of the current node satisfies a first condition.

The seventh determining module 93 is configured to determine that the identifier of the current node has a second identifier value when the location information of the current node satisfies a second condition.

The identifier indicates whether a planar mode is allowed to be used to encode the current node; the first identifier value indicates that the planar mode is allowed to be used to encode the current node; and the second identifier value indicates that the planar mode is not allowed to be used to encode the current node.

In an optional embodiment, the first condition includes that:
the location information of the current node indicates that the number of nodes in a N-th layer in which the current node is located is less than a product of the number of nodes in a (N−1)-th layer and a first preset value; or the location information of the current node indicates that an occupancy pattern of neighbouring nodes of the current node is equal to a second preset value.

In an optional embodiment, the second condition includes that:
the location information of the current node indicates that the number of nodes of a N-th layer in which the current node is located is greater than a product of the number of nodes of a (N−1)-th layer and a first preset value, and the location information of the current node indicates that an occupancy pattern of neighbouring nodes of the current node is not equal to a second preset value.

In an optional embodiment, when the number of nodes of the N-th layer is 1, the number of nodes of the (N−1)-th layer is 0.

In an optional embodiment, the first preset value is 2.

In an optional embodiment, the second preset value is any one integer greater than or equal to 0 and less than or equal to 63.

In an optional embodiment, the first identifier value is 1, and the second identifier value is 0.

In practical applications, the fifth determining module 91, the sixth determining module 92 and the seventh determining module 93 may be implemented by processor(s) located on the encoder, specifically by devices such as the CPU, the MPU, the DSP, or the FPGA.

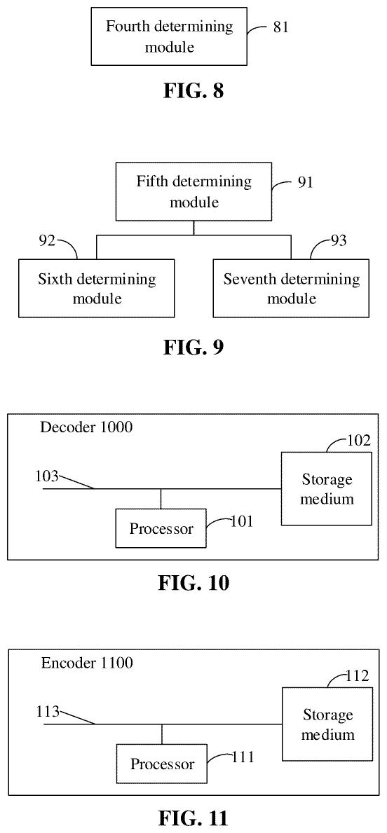

An embodiment of the present disclosure provides a decoder. FIG. 10 is a third schematic diagram of an optional structure of a decoder according to the embodiment of the present disclosure. As illustrated in FIG. 10, the embodiment of the present disclosure provides a decoder 1000, including:
a processor 101 and a storage medium 102 storing instructions executable by the processor 101, where the storage medium 102 implements operations by the processor 101 through a communication bus 103; and the instructions, when being executed by the processor 101, implement the point cloud decoding method in one or more embodiments described above.

It is to be noted that in practical applications, the various components in the terminal are coupled together through the communication bus 103. It can be understood that the communication bus 103 is used to implement connection communication between these components. The communication bus 103 includes a power bus, a control bus and a status signal bus in addition to a data bus. But for clarity, the various buses are designated as communication bus 103 in FIG. 10.

An embodiment of the present disclosure provides an encoder. FIG. 11 is a second schematic diagram of an optional structure of an encoder according to the embodiment of the present disclosure. As illustrated in FIG. 11, the embodiment of the present disclosure provides an encoder 1100, including:
a processor 111 and a storage medium 112 storing instructions executable by the processor 111, where the storage medium 112 implements operations by the processor 111 through a communication bus 113; and the instructions, when being executed by the processor 111, implement the point cloud encoding method in one or more embodiments described above.

It is to be noted that in practical applications, the various components in the terminal are coupled together through the communication bus 113. It can be understood that the communication bus 113 is used to implement connection communication between these components. The communication bus 113 includes a power bus, a control bus and a status signal bus in addition to a data bus. But for clarity, the various buses are designated as communication bus 113 in FIG. 11.

An embodiment of the present disclosure provides a bitstream, where the bitstream is generated by performing bit-encoding based on information to-be-encoded, the information to-be-encoded including at least an identifier of a current node.

An embodiment of the present disclosure provides a computer-readable storage medium having stored thereon executable instructions that, when executed by one or more processors, implement the point cloud decoding method in one or more embodiments described above or the point cloud encoding method in one or more embodiments described above.

The computer-readable storage medium may be a ferromagnetic random access memory (FRAM), a Read Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disc, or a Compact Disc Read-Only Memory (CD-ROM), and the like.

Those skilled in the art should understand that the embodiments of the present disclosure may be provided as methods, systems, or computer program products. Therefore, the present disclosure may be implemented in the form of hardware embodiments, software embodiments, or embodiments that combine both software and hardware aspects. Furthermore, the present disclosure may be implemented in the form of a computer program product on one or more computer-usable storage medium (including but not limited to disk storage and optical storage) that contain computer-usable program code.

The present disclosure is described with reference to flowcharts and/or block diagrams of methods, devices (systems) and computer program products according to the embodiments of the present disclosure. It is to be understood that each flow in the flowchart and/or each block in block diagram, as well as combinations of the flows in the flowchart and/or blocks in block diagram, may be implemented by computer program instructions. These computer program instructions may be provided to a processor of a general purpose computer, a special purpose computer, an embedded processor, or other programmable data processing device to generate a machine, such that instructions executed by a processor of a computer or other programmable data processing device generate apparatus for performing the functions specified in one or more flow in the flowchart and/or one or more blocks in the block diagram.

These computer program instructions may also be stored in a computer readable memory that directs a computer or other programmable data processing device to operate in a specific manner, so that the instructions stored in such computer readable memory produce an article of manufacture including the instruction means, the instruction means implements the functions specified in one or more flow in the flowchart and/or one or more blocks in the block diagram.

These computer program instructions may also be loaded onto a computer or other programmable data processing device, such that a series of operational steps are executed on a computer or other programmable device to produce a computer-implemented process, such that instructions executed on the computer or other programmable device provide operations for implementing the functions specified in one or more flow in the flowchart and/or one or more blocks in the block diagram.

The above description is merely the preferable embodiments of the present disclosure, and is not intended to limit the scope of protection of the present disclosure.

### INDUSTRIAL APPLICABILITY

In the embodiments of the present disclosure, at the encoding and decoding ends, a value of the identifier of the current node is assigned accordingly based on whether the location information of the current node satisfies the first condition or the second condition, so that whether the planar mode is allowed to be used for decoding or encoding the current node can be determined with reduced computational effort. Moreover, at the decoding end, the value of the identifier of the current node can be decoded from the bitstream, thereby determining whether the planar mode is allowed to be used for decoding the current node, which simplifies the computational complexity while improving the encoding and decoding gains of the planar mode compared to a manner used in related art for determining whether the planar mode is allowed to be used for decoding or encoding the current node.

1. A point cloud decoding method, applied to a decoder, the method comprising:
decoding a point cloud bitstream, and determining location information of a current node;
determining that an identifier of the current node has a first identifier value when the location information of the current node satisfies a first condition; and
determining that the identifier of the current node has a second identifier value when the location information of the current node satisfies a second condition;
wherein the identifier indicates whether a planar mode is allowed to be used to decode the current node; the first identifier value indicates that the planar mode is allowed to be used to decode the current node; and the second identifier value indicates that the planar mode is not allowed to be used to decode the current node.

2. The method of claim 1, wherein the first condition comprises that:
the location information of the current node indicates that a number of nodes in a N-th layer in which the current node is located is less than a product of a number of nodes in a (N−1)-th layer and a first preset value; or the location information of the current node indicates that an occupancy pattern of neighbouring nodes of the current node is equal to a second preset value.

3. The method of claim 1, wherein the second condition comprises that:
the location information of the current node indicates that a number of nodes of a N-th layer in which the current node is located is greater than a product of a number of nodes of a (N−1)-th layer and a first preset value, and the location information of the current node indicates that an occupancy pattern of neighbouring nodes of the current node is not equal to a second preset value.

4. The method of claim 2, wherein when the number of nodes of the N-th layer is 1, the number of nodes of the (N−1)-th layer is 0.

5. The method of claim 2, wherein the first preset value is 2.

6. The method of claim 2, wherein the second preset value is any one integer greater than or equal to 0 and less than or equal to 63.

7. The method of claim 1, wherein the first identifier value is 1, and the second identifier value is 0.

8. A point cloud encoding method, applied to an encoder, the method comprising:
determining location information of a current node;
determining that an identifier of the current node has a first identifier value when the location information of the current node satisfies a first condition; and
determining that the identifier of the current node has a second identifier value when the location information of the current node satisfies a second condition;
wherein the identifier indicates whether a planar mode is allowed to be used to encode the current node; the first identifier value indicates that the planar mode is allowed to be used to encode the current node; and the second identifier value indicates that the planar mode is not allowed to be used to encode the current node.

9. The method of claim 8, wherein the first condition comprises that:
the location information of the current node indicates that a number of nodes in a N-th layer in which the current node is located is less than a product of a number of nodes in a (N−1)-th layer and a first preset value; or the location information of the current node indicates that an occupancy pattern of neighbouring nodes of the current node is equal to a second preset value.

10. The method of claim 8, wherein the second condition comprises that:
the location information of the current node indicates that a number of nodes of a N-th layer in which the current node is located is greater than a product of a number of nodes of a (N−1)-th layer and a first preset value, and the location information of the current node indicates that an occupancy pattern of neighbouring nodes of the current node is not equal to a second preset value.

11. The method of claim 9, wherein when the number of nodes of the N-th layer is 1, the number of nodes of the (N−1)-th layer is 0.

12. The method of claim 9, wherein the first preset value is 2.

13. The method of claim 12, wherein the second preset value is any one integer greater than or equal to 0 and less than or equal to 63.

14. The method of claim 8, wherein the first identifier value is 1, and the second identifier value is 0.

15. The method of claim 8, further comprising:
encoding a value of the identifier of the current node, and signalling obtained encoded bits into a bitstream.

16. A decoder, comprising:
a processor and a storage medium storing instructions executable by the processor,
wherein the processor is configured to:
decode a point cloud bitstream and determine location information of a current node;
determine that an identifier of the current node has a first identifier value when the location information of the current node satisfies a first condition; and
determine that the identifier of the current node has a second identifier value when the location information of the current node satisfies a second condition;
wherein the identifier indicates whether a planar mode is allowed to be used to decode the current node; the first identifier value indicates that the planar mode is allowed to be used to decode the current node; and the second identifier value indicates that the planar mode is not allowed to be used to decode the current node.

17. The decoder of claim 16, wherein the first condition comprises that:
the location information of the current node indicates that a number of nodes in a N-th layer in which the current node is located is less than a product of a number of nodes in a (N−1)-th layer and a first preset value; or the location information of the current node indicates that an occupancy pattern of neighbouring nodes of the current node is equal to a second preset value.

18. The decoder of claim 16, wherein the second condition comprises that:
the location information of the current node indicates that a number of nodes of a N-th layer in which the current node is located is greater than a product of a number of nodes of a (N−1)-th layer and a first preset value, and the location information of the current node indicates that an occupancy pattern of neighbouring nodes of the current node is not equal to a second preset value.

19. The decoder of claim 17, wherein when the number of nodes of the N-th layer is 1, the number of nodes of the (N−1)-th layer is 0.

20. The decoder of claim 17, wherein the first preset value is 2.
